(19) United States
(12) Patent Application Publication
(10) Pub. No.: US 2003/0021970 A1
(43) Pub. Date: Jan. 30, 2003

(54) Nonwoven comprising a batt of continuous filaments, its manufacturing process and its application as a cleaning cloth

(76) Inventor: Frederic Noelle, Saint-Nazaire Les Eymes (FR)

Correspondence Address: PEARNE & GORDON LLP, 526 SUPERIOR AVENUE EAST, SUITE 1200, CLEVELAND, OH, 44114-1484, US

(21) Appl. No.: 10/186,536

(22) Filed: Jul. 1, 2002

(30) Foreign Application Priority Data
Jul. 10, 2001 (FR) 01 09128

(51) Int. Cl. B32B 1/00; D04H 1/46; D04H 1/70; D04H 3/02

(52) U.S. Cl. 428/212; 428/218; 428/219; 442/384; 28/104

(57) ABSTRACT

Nonwoven which comprises at least one hydroentangled web of thermoplastic discontinuous fibres, hydroentangled with an unstretched batt of independent, inelastic, continuous filaments oriented at random.

Nonwoven comprising a batt of continuous filaments, its manufacturing process and its application as a cleaning cloth

The present invention relates to nonwovens, to their manufacturing process and to their use as a cleaning cloth.

In order to produce such cleaning articles, it is known to consolidate thermoplastic fibre webs by hot calendering. The calendering operation effects a pointwise melting of the thermoplastic fibres of the nonwoven and thus imparts its cohesion and its mechanical strength thereto. The products arising from such a consolidation process have low mechanical strength, low tear strength, and a high weight per unit volume. These properties are not the best which may be desired for a dry-cleaning cloth.

To alleviate the problems of mechanical strength and of tear strength, it has also been proposed in patent U.S. Pat. No. 5,525,397 that fibrous webs based on thermoplastic fibres be associated with a very expensive synthetic network sheet made in particular of polyolefins, the various components of the nonwoven being consolidated together by the action of pressurized water jets. Such products have low mechanical strength, since it is essentially afforded by the network sheet of low weight per square metre situated between the fibrous layers. On the other hand, such products have sufficient tear strength and a low weight per unit volume which assist their good dust capture performance.

In EP-0814189A there is described a strong and stable, voluminous nonwoven product pleasant to the touch, composed of short fibres of several batts of filaments disposed in a unidirectional manner and stretched.

Now, and this is what forms the subject of the present invention, a nonwoven structure and its stretchless manufacturing process have been found which make it possible to produce not only dry-cleaning cloths having both excellent mechanical properties as regards tensile and tear strength, very small weight per unit volume well suited to the capture of a large quantity of duct and suited to the capture of dust of large dimensions such as hairs and bristles, and whose electrostatic properties are very good, but also being less expensive thereby allowing savings of 30 to 40% of the production cost as compared with the technique of the abovementioned American patent since no expensive network sheet which complicates the manufacturing process is employed.

The subject of the invention is a nonwoven which comprises at least one web of thermoplastic discontinuous fibres which is hydroentangled with an unstretched batt of independent, inelastic, continuous filaments oriented at random.

The expression independence of the continuous filaments is understood to mean that there is no point of melting between them. A filament has a diameter of between 10 and 30 microns and consists, unlike an elastic thread as envisaged in WO 9406956, of a single strand and not of strands twisted or texturized together. The random orientation of the filaments is manifested in the nonwoven by the fact that the ratio of the tensile breaking strength in the direction in which it is largest to that in which it is smallest is less than 5 and preferably, less than 3 and better still less than 2.

This ratio is measured by measuring the tensile strengths in the machine direction, then at 15°, 30°, 45°, 60°, 75° and in the crosswise direction, taking the ratio of the greatest strength to the smallest. The inelasticity of the filaments is such that they do not return to their original length when they are related after stretching. It is such that the nonwoven has an elastic range of 0-5% and preferably 0-1%. It does not return to the original length as soon as it is stretched beyond 5% or, preferably, beyond 1%.

In order for the nonwoven's feel to the touch to be better, it is preferable for it to comprise a batt interposed between two webs.

After manual separation of the webs and the batt, each web preferably has a thickness of between 0.30 mm and 0.80 mm and the batt of filaments preferably has a thickness of between 0.20 mm and 0.60 mm.

Preferably, the nonwoven according to the invention has a weight per unit volume of not greater than 0.06 g/cm³. This lightness enables it to retain dust well.

The initial surface potential of a circular sample 80 mm in diameter of the nonwoven according to the invention, which has undergone a corona discharge of −8 KV, is, in absolute value, greater than 2000 volts and, after 10 min, greater than 1500 volts.

When it is used as a cleaning cloth, the nonwoven according to the invention has good mechanical strength perfectly suited to the constraints induced by the cleaning operations and a sufficiently small weight per unit volume to capture a large quantity of dust and to capture particles of large dimensions such as hairs and bristles. On account of the small weight per unit volume of the nonwoven, the dust can lodge in the interstices between the fibres or even get intertwined with the loose fibres of the nonwoven. These properties, together with the good electrostatic properties, assist in attracting dust.

A nonwoven is thus obtained which has the surface potential of a circular sample 80 mm in diameter having undergone a corona discharge of −8 k/volts and is, after 10 minutes, in absolute value, greater than 1500 volts; after manual separation of the webs and batts, each web has a thickness of between 0.30 mm and 0.80 mm and the batt has a thickness between 0.20 mm and 0.60 mm, which has a tensile strength in the lengthwise direction of greater than 30 N, which has a tensile strength in the crosswise direction of greater than 30 N, which has a tensile elongation in the lengthwise direction in % of greater than 30 and crosswise direction of greater than 30. The weight per unit area is between 35 and 100 g/m².

The invention is also aimed at a process for manufacturing a nonwoven which consists in calendering a batt of inelastic continuous filaments oriented at random at a temperature below the melting point of the material which constitutes them and under a calendering pressure of less than 50 N/mm in such a way as to give the batt a breaking length of less than 1020 m, in manufacturing at least one web of thermoplastic discontinuous fibres, in hydroentangling the batt and the at least one web with a bonding energy of less than 0.15 KWh/Kg in such a way as to obtain a wet nonwoven and in drying the wet nonwoven.

The cleaning cloth can then comprise a batt of continuous filaments made for example of polypropylene or polyethylene, lightly calendered to obtain the cohesion of the batt without melting of the filaments. The lightly calendered batt of continuous filaments can have a weight per unit area of between 5 and 40 g/m² and preferably of between 15 and 30 g/m².

The batt of continuous filaments of polypropylene is calendered at a temperature of below 1000C and a calendering pressure of below 50 N/mm so as to avoid the melting of the filaments. The cohesion afforded by the calendering is just sufficient to wind up the batt and unwind it without breaking it.

It exhibits a breaking length of less than 1020 m. The breaking length L is defined by the EDANA (European Disposables And Nonwovens Association) by the following formula:

L=F×10⁶/(w×g×9.81)

L=breaking length in metres

F=breaking force in Newtons

w=width of the tensile specimen in mm

g=weight per square metre of the nonwoven tested

This characteristic is crucial since it conditions the good thermoplastic gripping of the fibres at low bonding energy level using water jets. Specifically, at low bonding energy level using water jets, the nonwoven retains its volume and its low weight per unit volume and hence its good cleaning and dust capture performance. In the converse case, if the breaking length of the batt of continuous filaments is greater than 1020 m, the hydraulic energy required to have good cohesion of the various layers is too high and causes excess consolidation which increases the weight per unit volume of the cleaning cloth and reduces its cleaning performance.

On this batt of continuous filaments are deposited, preferably on each side, thermoplastic fibre webs of 10 to 30 g/m² preferably carded. These fibre webs will preferably consist of polyester or polypropylene fibres of linear density lying preferably between 1 dtex and 3.3 dtex and from 20 to 60 mm long, preferably from 38 to 55 mm long.

The various layers are consolidated and entangled together by action of water jets at a pressure of below 200 bar and a hydraulic bonding energy of less than 0.25 kWh/kg.

The nonwoven is dried in a through-air oven at a temperature of 120° C. and at a rate of 20 m/min. Drying is terminated when the nonwoven has a residual moisture of between 2% and 5%. The cleaning cloth exhibits a final density of less than or equal to 0.06 g/cm³.

It is possible to proceed thus without performing any stretching throughout the process, which stretching would require greater consolidation by melting which would prevent the achieving of the cleaning processes.

The hydraulic bonding energy can be measured in the following manner.

For each injector, the flow rate Dᵢ is calculated, followed by the hydraulic energy Eᵢ.

Dᵢ=3600*k*n*(H*d²/4)*√(2*g*p*10)

Eᵢ−Dᵢ*p/36

Dᵢ=flow rate of water per injector expressed in m³/h per metre of working width.

Eᵢ=hydraulic bonding energy per injector expressed in kWh per metre of working width.

d=diameter of the holes shaping the jets and expressed in metres.

k=coefficient depending on the shape of the holes. Generally equal to 0.70.

Π=Pythagorus number

n=number of jets per metre

p=water pressure expressed in bars

g=acceleration due to gravity equal to 9.81 ms-⁻²

Next, the total hydraulic bonding energy is obtained by summing the Eᵢ for each injector:

E_{HT}=Eᵢ₁+Eᵢ₂+. . . +Eᵢₙ

Next, the total production of nonwovens in kg/h and per metre of working width is obtained according to the formula:

P_{T}=m*v*60

P_{T}=total production of nonwoven in kg/h and per metre of working width.

m=weight per unit area of the nonwoven in kg/m²

V=rate of production in metres per minute.

Finally, the hydraulic bonding energy expressed in kWh/kg of production is obtained according to the formula:

E_{L}=E_{HT}/P_{T}.

The drying stage can be performed with hot air.

The invention and the advantages which stem therefrom will be better understood by virtue of the exemplary embodiments which follow, given by way of nonlimiting indication, and which are illustrated by the appended drawings, in which:

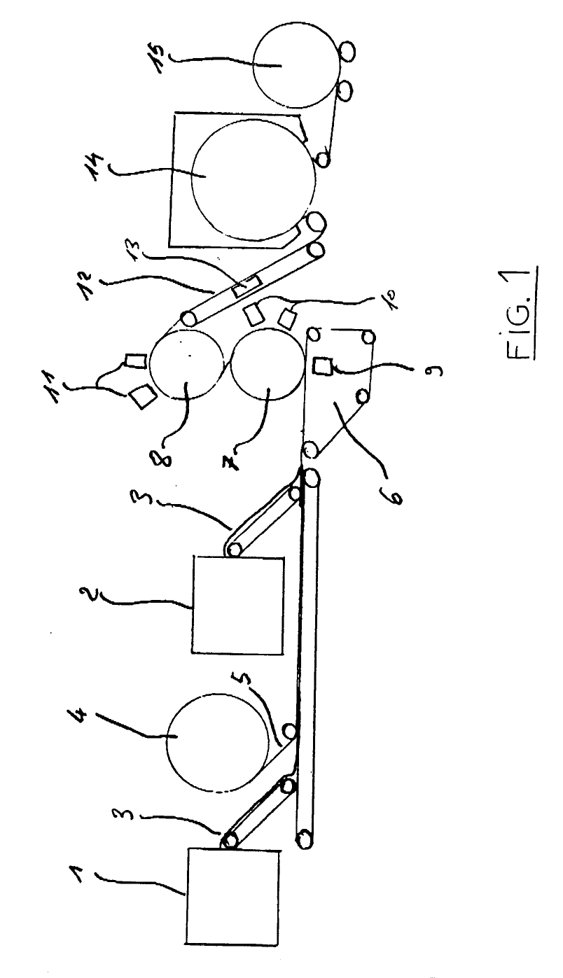

FIG. 1 represents a plant making it possible to produce nonwovens in accordance with the invention,

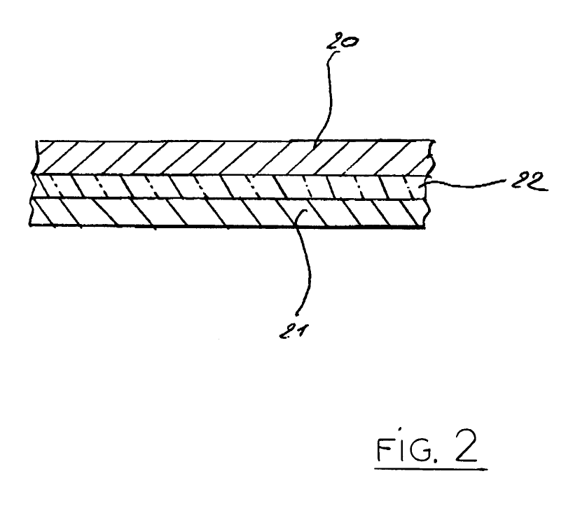

FIG. 2 is a sectional view of a nonwoven in accordance with the invention,

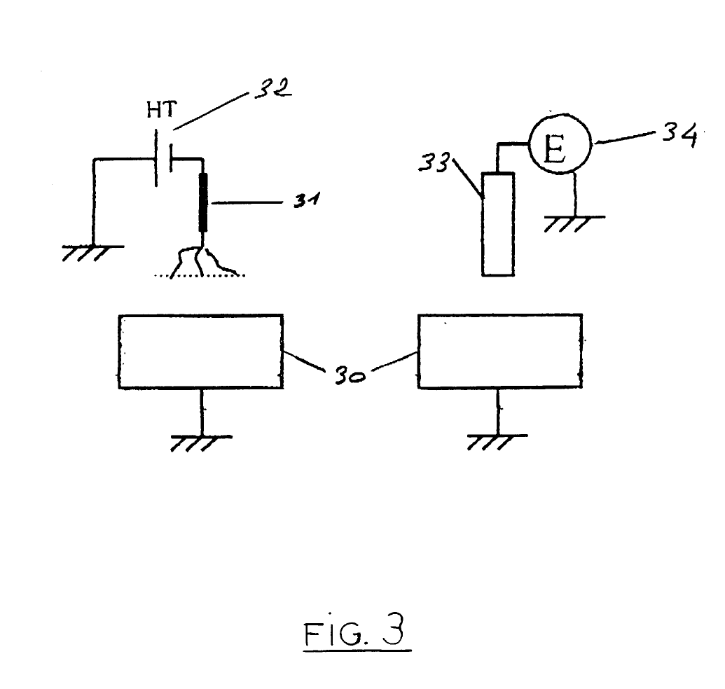

FIG. 3 diagrammatically represents the plant for measuring surface potential, and

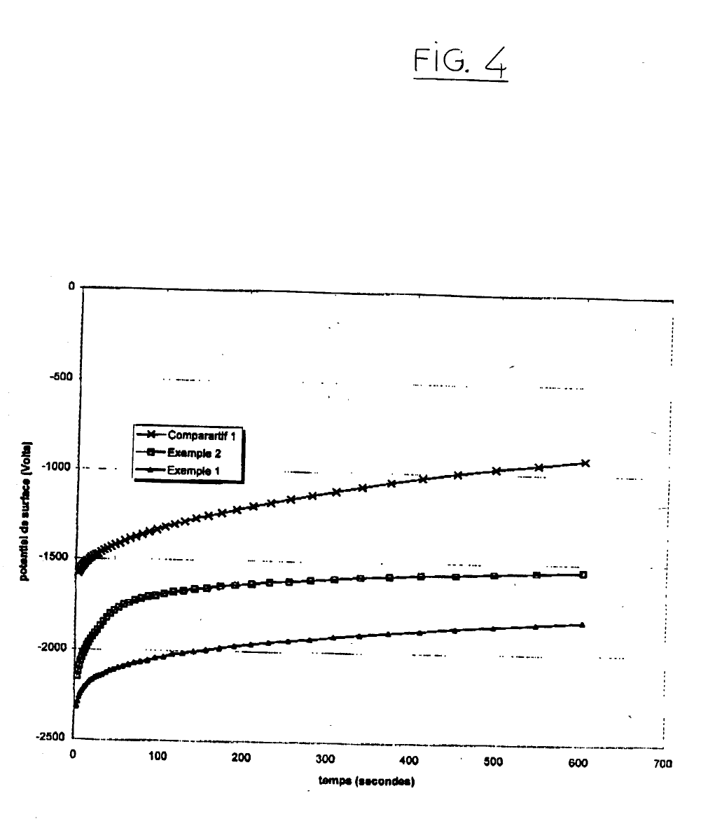

FIG. 4 is a graph giving the surface potential in volts of the nonwovens of the examples versus time.

Referring to the appended figures, and more especially to FIG. 1, a production line for making a nonwoven in accordance with the invention is composed essentially of an assembly, designated by the general references 1 and 2, making it possible to produce by carding or some other similar technique, two batts consisting of synthetic fibres such as polyester or polypropylene.

Between the two carded synthetic fibre batts 3 is unwound by way of a feed roll 4 a lightly calendered batt of continuous filaments 5.

The batt of independent continuous filaments preferably consists of continuous filaments of polypropylene.

The batt of continuous filaments is formed by a melt route, for example by the process known by the term spunbond.

The batt of continuous polypropylene filaments is calendered at a temperature of below 100° C. and a calendering pressure of below 50 N/mm so as to avoid the melting of the filaments.

The breaking length of the continuous polypropylene filaments is less than 1020 m.

On this batt of continuous filaments are deposited, preferably on each side, thermoplastic fibre webs of 10 to 30 g m², preferably carded, that is to say arising from textile machines for forming fibre webs known as cards. These fibre webs will preferably consist of polyester or polypropylene fibres of linear density lying between 1 dtex and 3.3 dtex, preferably 1.7 dtex and 20 to 60 mm long, preferably 38 to 55 mm long.

The assembly of the three superimposed batts is transported on a conveyor belt 6 into a water jet bonding machine with two cylinders 7 and 8 for example.

The assembly consisting of the three layers is firstly compressed mechanically between the conveyor 6 and the first cylinder 7 and is then wetted by a first injector 9 delivering low-pressure water jets. The assembly is consolidated by a first series of injectors 10 delivering high-pressure water jets.

Next, the assembly consisting of the three layers is transferred to a second cylinder 8 on which it is consolidated by the action of a second series of injectors 11. It is then expressed onto a conveyor 12 equipped with a suction plenum 13 linked to a vacuum source.

The consolidation of the various layers is carried out with a bonding energy of less than 0.25 kWh/kg and preferably below 0.15 kWh/kg. The final weight per unit volume thus obtained is below 0.06 g/cm³.

The nonwoven thus obtained is dried in a through-air oven 14 and is then received on a takeup roll 15

FIG. 2 is a sectional view of a cleaning cloth such as obtained according to the invention. The outer layers 20 and 21 consist of thermoplastic fibres of polyester or polypropylene. A layer 22 of spunbond continuous filaments has been inserted between these layers of thermoplastic fibres.

The laboratory tests for measuring thickness, weight per unit volume, strength in the lengthwise direction and in the crosswise direction, elongation in the lengthwise direction and in the crosswise direction, and lengthwise and crosswise tearing are conducted according to the ERT standards of the EDANA (European Disposables And Nonwovens Association), namely

a) Thickness

The sample is conditioned for 24 hours and the test is performed at 23° C. and at a relative humidity of 50%. The thickness of the nonwoven is measured by measuring the distance between a reference platen on which the nonwoven is laid and a parallel presser platen which applies a precise pressure to the surface subjected to the test. The apparatus consists of two circular horizontal plates fixed to a frame. The upper plate moves vertically. It has an area of around 2500 mm². The reference plate has a plane surface with a diameter at least 50 mm larger than that of the upper plate. A rig is provided enabling the piece subjected to the test to be suspended vertically between the two platens.

The test piece has dimensions of 180×80 mm plus or minus 5 mm for the width and the length. There is provided a device for measuring the distance between the plates when the latter are brought together to the point of applying a pressure of 0.02 kpa.

b) Strength and Elongation in the Lengthwise Direction and in the Crosswise Direction

A sample is conditioned for 24 hours and the test is performed at 23° C. and at a relative humidity of 50%. A dynamometer comprising a set of fixed jaws and a set of moving jaws travelling at a constant speed is used for the test. The jaws of the dynamometer have a working width of 50 mm. The dynamometer is equipped with a recorder which makes it possible to plot the curve of tensile force versus elongation. Five samples 50 mm plus or minus 0.5 mm wide and 250 mm long are cut out, in the lengthwise and in the crosswise direction of the nonwoven. The samples are tested one by one, at a constant pulling rate of 100 mm per minute and with an initial distance between jaws of 200 mm. The dynamometer records the curve of pulling force in Newtons versus elongation.

c) Tearing Strength in the Lengthwise Direction and in the Crosswise Direction:

A sample is conditioned for 24 hours and the test is performed at 23° C. and at a relative humidity of 50%.

A dynamometer comprising a set of fixed jaws and a set of moving jaws travelling at a constant speed is used for the test. The jaws of the dynamometer have a working width of 50 mm. The dynamometer is equipped with a recorder which makes it possible to plot the curve of the tensile force as a function of the travel of the moving jaws. Five samples 75 mm plus or minus 1 mm wide and 150 mm plus or minus 2 mm long are cut out, in the lengthwise direction and in the crosswise direction of the nonwoven. The 150 mm large side is cut out in the machine direction or crosswise direction to be tested. Two oblique lines are plotted defining an isosceles trapezium with 25 mm base times 100 mm base and 75 mm high and whose bases are centred 75 mm from the edges of the specimens. A small 5 mm notch is made with the aid of scissors at the centre of the 25 mm base of each trapezium. The aim of this notch is to initiate tearing during the tests.

The samples are tested one by one. The jaws of the dynamometer are placed an initial distance of 25 mm apart. The sample is placed between the jaws in such a way that the small base of the trapezium is slightly taut and that the large base of the trapezium is loose.

The samples are tested at a constant pulling rate of 100 mm per minute.

d) Weight Per Square Metre:

A sample is conditioned for 24 hours and the test is performed at 23° C. and at a relative humidity of 50%.

At least 3 samples with an area of at least 50,000 mm² are cut out with a cutting apparatus called a trimmer.

Each sample is weighed on a laboratory balance having an accuracy of 0.1% of the weight of the samples weighed.

e) Weight Per Unit Volume:

The weight per unit volume is calculated from the measured thickness and from the weight per square metre.

mv=g/ex 1000

mv=weight per unit volume in grams per centimetre cubed

g=weight per square metre of the nonwoven

e=thickness of the nonwoven tested.

f) Dust Capture:

The dust capture test consists in taking a 10 cm by 15 cm cloth. This size of cloth is well suited to the area of a hand. Dust consisting of household dust and cut hairs is deposited in a uniform layer on a 1 square metre plane surface. The cloth is weighed before cleaning and after cleaning which consists in passing the cloth over the surface until the cloth is saturated, that is to say until the dust is no longer captured by the cloth. The dust capture is calculated as a percentage of the unsoiled cleaning cloth weight according to the formula:

100×(M2−M1)/M1

where

M1 is the weight expressed in grams of the cloth before cleaning

M2 is the weight expressed in grams of the cloth after cleaning

g) Measurement of Surface Potential

FIG. 3 is a diagrammatic representation of the laboratory equipment used for the surface potential measurements.

A sample 80 mm in diameter is disposed on an earthed circular sample holder 30.

The sample is placed under a needle 31 linked to a high voltage generator 32.

A corona discharge of −8 kvolts is created between the needle and the sample for one second.

Once the sample has been charged, it is automatically positioned under an electrostatic measurement probe 33, made by Monroe. This probe is connected to an electrostatic voltmeter 34 which makes it possible to measure the surface potential of the sample. The voltmeter is linked to a PC which carries out the acquisition of the values of surface potential versus time. The measurement of the surface potential is continued for 10 minutes and a curve of decay of surface potential versus time is then plotted.

The test is repeated 5 times on 5 different circular samples for each nonwoven.

The following examples and the comparative example illustrate the invention.

### EXAMPLE 1:

A lightly calendered batt of spunbond polypropylene continuous filaments of 20 g/m² is disposed between 2 carded polyester fibre webs each of 20 g/m². The polyester fibres have a linear density of 1.7 dtex and a length of 38 mm. The assembly consisting of the 3 superimposed layers is subjected to the action of water jets in a plant such as described in FIG. 1 and with a consolidation energy of 0.12 kwh/kg. The nonwoven thus obtained is then dried at a temperature of 120° C. in a through-air oven at a rate of 20 m/min. A nonwoven is obtained with a weight per unit area of 60 g/m² and with a ratio R of tensile breaking strength in the machine direction to that in the crosswise direction of less than 2.

### EXAMPLE 2:

Example 1 is repeated, replacing the two polyester fibre webs with 2 polypropylene fibre webs each of 20 g/m². The polypropylene fibres have a linear density of 1.7 dtex and a length of 40 mm. The assembly consisting of the three superimposed layers is subjected to the action of water jets in a plant such as described in FIG. 1 and with a consolidation energy of 0.12 kWh/kg. The nonwoven thus obtained is then dried at a temperature of 120° C. in a through-air oven at a rate of 20 m/min. A nonwoven with a weight per unit area of 60 g/m² and with R<2 is obtained.

### Comparative Example 1

A conventional nonwoven for a cleaning cloth consisting of a reinforcing network sheet made of polypropylene between two layers of polyester fibres is made in the following manner.

A 5 g/m² extruded polypropylene network sheet comprising 10 threads per centimetre lengthwise and 9 threads per centimetre crosswise is disposed between 2 carded polyester fibre webs each of 28 g/m². The polyester fibres have a linear density of 1.7 dtex and a length of 38 mm. The polyester fibres are identical to those used in Example 1. The assembly consisting of the three superimposed layers is subjected to the action of water jets in a plant such as described in FIG. 1 and with a consolidation energy of 0.12 kWh/kg. The nonwoven thus obtained is then dried at a temperature of 120° C. in a through-air oven at a rate of 20 m/min. A nonwoven with a weight per unit area of 60 g/M² is obtained.

The products obtained in accordance with the invention and that of the comparative example are tested to determine the thickness, the weight per unit volume, the strength in the lengthwise direction and in the crosswise direction, the elongation in the lengthwise direction and in the crosswise direction, the surface potential after corona discharge and its time profile. The results are grouped together in Table 1 and the graph of FIG. 4.

Relative to the products made in the customary manner, and as emerges from the table of results, the nonwovens made in accordance with the invention have the advantage of taking a greater charge of static electricity at the surface and of retaining this electrostatic charge for a long time. They also have the advantage of capturing considerably more dust.

Moreover, their weight per unit volume is smaller than that of the conventional products, that is to say their thickness for the same weight per square metre is greater than a customary cleaning nonwoven. This being favourable to the capture of dust of large dimensions.

Moreover, their strength both in the lengthwise direction and in the crosswise direction are better than that of the customary cleaning nonwoven, thereby guaranteeing them stability and resistance to wear.

TABLE 1

| | | | | Compara- |
|---|---|---|---|---|
| Characteristics | Units | Example 1 | Example 2 | tive 1 |
| Weight | g/m² | 59 | 59 | 60 |
| Thickness | mm | 1.25 | 1.25 | 0.92 |
| Weight per unit | g/cm³ | 0.05 | 0.05 | 0.07 |
| volume | | | | |
| Lengthwise strength | N/50 mm | 135 | 193 | 30.7 |
| Crosswise strength | N/50 mm | 102 | 105 | 63.0 |
| Lengthwise | % | 92 | 114 | 29.7 |
| elongation | | | | |
| Crosswise | % | 131 | 169 | 47.0 |
| elongation | | | | |
| Lengthwise tear | N/50 mm | 35.6 | 25.7 | 8.12 |
| strength | | | | |
| Crosswise tear | N/50 mm | 37.3 | 34.8 | 18.7 |
| strength | | | | |
| Initial surface | Volts | −2320 | −2230 | −1590 |
| potential | | | | |
| Surface potential | Volts | −2079 | −1739 | −1382 |
| after 1 minute | | | | |
| Surface potential | Volts | −1819 | −1542 | −917 |
| after 10 minutes | | | | |
| Dust captured | % | 196 | 162 | 90 |

The cleaning cloth according to the invention can be used inparticular for the dry cleaning of any surface, in particular one made of metal, plastic, ceramic, glass, fabric in the following manner:

The cloth is held in the hand and applied to the surface to be cleaned with either a straight movement or one in small circles. A single pass is sufficient.

When the cloth is saturated with dust, it is discarded and replaced with an unsoiled cloth.

1. A nonwoven which comprises at least one hydroentangled web of thermoplastic discontinuous fibres, hydroentangled with an unstretched batt of independent, inelastic, continuous filaments oriented at random.

2. The nonwoven according to claim 1, wherein the batt interposed between two webs.

3. The nonwoven according to claim 1, wherein the ratio of the tensile breaking strength in the direction in which it is largest to that in which it is smallest is less than 5.

4. The nonwoven according to claim 1, wherein it has a weight per unit volume of not greater than 0.06 g/cm².

5. The nonwoven according to claim 1, wherein the initial surface potential of a circular sample 80 mm in diameter, having undergone a corona discharge of −8 k/volts, is, in absolute value, greater than 2000 volts.

6. The nonwoven according to claim 1, wherein the surface potential of a circular sample 80 mm in diameter having undergone a corona discharge of −8 k/volts is, after 10 minutes, in absolute value, greater than 1500 volts.

7. The nonwoven according to claim 1, wherein it has a weight per unit area of between 35 and 100 g/m².

8. The nonwoven according to claim 1, wherein after manual separation of the webs and batt, each web has a thickness of between 0.30 mm and 0.80 mm and the batt has a thickness of between 0.20 mm and 0.60 mm.

9. The nonwoven according to claim 1, wherein it has a tensile strength in the lengthwise direction of greater than 30 N/50 mm.

10. The nonwoven according to claim 1, wherein it has a tensile strength in the crosswise direction of greater than 30 N/50 mm.

11. The nonwoven according to claim 1, wherein it has a tensile elongation in the lengthwise direction in % of greater than 30%.

12. The nonwoven according to claim 1, wherein that it has a tensile elongation in % in the crosswise direction of greater than 20 N.

13. The nonwoven according to claim 1, wherein it has a tear strength in the lengthwise direction of greater than 20 N.

14. The nonwoven according to claim 1, wherein it has a tear strength in the crosswise direction of greater than 20 N.

15. A process for cleaning comprising using a cleaning cloth a nonwoven which comprises at least one hydroentangled web of thermoplastic discontinuous fibres, hydroentangled with an unstretched batt of independent, inelastic, continuous filaments oriented at random.

16. Process for manufacturing a nonwoven comprising
calendering a batt of inelastic continuous filaments oriented at random at a temperature below the melting point of the material which constitutes them and under a calendering pressure of less than 50 N/mm in such a way as to give the batt a breaking length of less than 1020 m. manufacturing at least one web of thermoplastic discontinuous fibres,
hydroentangling the batt and the at least one web with a bonding energy of less than 0.25 kWh/Kg in such a way as to obtain a wet nonwoven, and
drying the wet nonwoven.

17. The process according to claim 16, wherein the batt is made of polypropylene.

18. The process according to claim 16, wherein the webs are carded and have a weight of 10 to 30 g/m².

19. The process according to claim 15, wherein the webs are made of polyester or polypropylene.

20. The process according to claim 15, wherein the fibres have a length of between 20 and 60 mm.

21. The process according to claim 15, wherein the fibres have a linear density of between 1 dtex and 3.3 dtex.
